(19) United States
(12) Patent Application Publication
(10) Pub. No.: US 2011/0247470 A1
(43) Pub. Date: Oct. 13, 2011

(54) APPARATUS FOR SLICING FOOD PRODUCTS

(75) Inventor: Günther Weber, Gross Nemerow (DE)

(73) Assignee: Weber Maschinenbau GmbH Breidenbach, Breidenbach (DE)

(21) Appl. No.: 13/079,168

(22) Filed: Apr. 4, 2011

(30) Foreign Application Priority Data
Apr. 7, 2010 (DE) 102010013893.2

(51) Int. Cl. B26D 5/02; B26D 7/06; B26D 7/26

(52) U.S. Cl. 83/401; 83/591

(57) ABSTRACT

An apparatus for slicing food products includes a product feed, at least one cutting blade which rotates about a blade axis and/or revolves about a center axis in planetary motion and to which at least one product to be sliced can be fed in a product feed direction and includes a blade holder to which the cutting blade can be attached. An adjustment device is provided by means of which the cutting blade is movable relative to the blade holder in an adjustment direction.

The invention relates to an apparatus for slicing food products, in particular to a high-performance slicer, having a product feed, at least one cutting blade which rotates about a blade axis and/or revolves about a center axis in planetary motion and to which at least one product to be sliced can be fed in a product feed direction and having a blade holder to which the cutting blade can be attached.

Such apparatus are generally known and serve to cut food products such as sausage, meat and cheese into slices at high speed. Typical cutting speeds lie between several 100 to some 1,000 cuts per minute. Modern high-performance slicers differ inter alia in the design of the cutting blade as well as in the manner of the rotary drive for the cutting blade. So-called scythe-like blades or spiral blades rotate about an axis of rotation also called a blade axis here, with this axis of rotation itself not carrying out any additional movement, with this, however, not being compulsory, i.e. alternatively, the axis of rotation itself can carry out an additional movement of any kind. Provision is, in contrast, made with slicer having circular blades to allow the rotating circular blade additionally to revolve in planetary motion about a further axis (here also called a center axis) spaced apart from the axis of rotation. Which blade type or which type of drive is to be preferred depends on the respective application. It can generally be stated that higher cutting speeds can be achieved with only rotating scythe-like blades, whereas rotating circular blades and circular blades additionally revolving in planetary motion can be used more universally without compromises in the cutting quality.

The above-mentioned high cutting speeds make it necessary—and this applies independently of the type of blade and of the type of drive—that, in particular with a portion-wise slicing of products, so-called blank cuts are carried out in which the blade continues to move, i.e. carries out its cutting movement, but does not cut into the product in so doing, but rather cuts into space so that temporarily no slices are cut off from the product and these “cutting breaks” can be used to transport away a portion formed with the previously cut off slices, for example a slice stack or slices arranged overlapping. The time elapsing between two slices cut off after one another is not sufficient for a proper transporting away of the slice portions from a specific cutting performance or cutting speed onward. The length of these “cutting breaks” and the number of blank cuts per “cutting break” are dependent on the respective application.

A problem known in practice in connection with the carrying out of blank cuts is that it is not sufficient in most cases simply to stop the feed of the product temporarily to prevent the cutting off of slices. With products having a soft consistency, it namely regularly occurs that after the stopping of the product feed, relaxation effects come into force, whereby the front product end moves beyond the cutting plane and thus enters into the active zone of the cutting blade. The consequence is an unwanted cutting off of so-called product snippets or product scraps. Apart from this, such scrap formation always necessarily occurs independently of the product consistency whenever the products are continuously supplied during the slicing operation, i.e. even with products of a solid consistency in which therefore the above-mentioned relaxation effects do not occur, there is scrap formation with a continuous product feed.

The above-described phenomena are sufficiently known to the skilled person so that they will not be looked at in more detail.

Measures are already known from the prior art, which serve to avoid scrap formation on the carrying out of blank cuts. Reference is made for this purpose, for example to EP 0 289 765 A 1, DE 42 14 264 A 1, EP 1 046 476 A2, DE 101 147 348 A1, DE 154 952, DE 10 2006 043 697 A1 and DE 103 33 661 A 1.

It has accordingly already been proposed not only to interrupt the product feed for the carrying out of blank cuts, but additionally to retract the product—if necessary together with the product support. This approach in particular reaches its limits when the cutting speeds and/or the masses to be moved in this process become too large since it can then no longer be ensured that the front product end can be retracted sufficiently fast. It has furthermore already been proposed as an alternative to the retraction of the product to move the cutting blade away from the front product end. Both solution approaches have the consequence that a sufficiently large spacing is established between the front product end and the cutting blade which reliably prevents scrap formation. The required blade stroke only amounts to some millimeters; however, it must take place in a very short time in the order of some hundredths of seconds. The possibility of a blade adjustment can also be utilized for further additional functions, e.g. for the setting of the cutting gap or for blank cuts within the framework of a vertical adjustment or an adjustment of the dipping depth of the cutting blade which in particular takes place with respect to the product or products to be sliced or with respect to the product support, which will be looked at in more detail in the following.

The prior art proposes various possibilities of establishing the desired spacing between the blade and product by a transposition of the blade.

One possibility, which is described, for example, in DE 101 47 348 A1, comprises only moving the rotating blade holder to which the blade is replaceably attached and which is also called a blade mount, blade shaft or rotor, and indeed relative to the other components of the so-called blade head which in particular includes, in addition to the mentioned blade holder, a rotary bearing for the rotational movement of the blade or of the blade holder as well as a base part with which the blade head and thus the blade holder is fastened to a rack or frame of the slicer. This fastening can take place, for example, at or in a so-called cutting head housing to which or in which not only the blade head together with the blade is attached, but also the drive motor for the rotary blade drive cooperating with the blade head e.g. via a drive belt

It is also possible to displace the blade head as a whole so that a relative movement between the blade holder and the rotary bearing of the blade is not required to adjust the blade. Such a solution is shown, for example in DE 10 2006 043 697 A1.

It is furthermore possible to move the whole cutting head housing together with the blade head and the rotary drive. Solutions of this kind are described, for example, in EP 1 046 476 A2.

These solution approaches explained above do not only differ with respect to the size of the mass to be moved, but also with respect to the construction effort as well as with respect to the applicability for different blade kinds or drive kinds. A movement of only the blade holder, for example, admittedly has the advantage of a relatively small mass to be moved, but does mean a relatively high construction effort since with the blade an object has to be displaced along an axis or moved in a different manner, said object simultaneously rotating at a high speed, e.g. about precisely the named axis. Problems in connection with the journaling of the blade or of the blade holder have to be solved for this purpose. Whereas the above-mentioned scythe-like blades or spiral blades only rotate about one axis, but this axis does not additionally carry out a revolving movement, concepts for the adjustment of the blade can be realized with a justifiable effort despite the mentioned journaling problems. This is different with slicers having rotating circular blades which simultaneously revolve in planetary motion since there is the problem here of effecting a transposition of only the blade or of the blade holder with a justifiable construction effort.

Independently of the construction problems with respect to the journaling of the blade or of the blade holder, in the known solution approaches, the achievable adjustment speed can be too low due to the masses to be moved in order to carry out blank cuts without quality losses at high cutting speeds.

It is therefore the object of the invention to improve the performance capability in a cutting apparatus of the above-named kind with respect to a blade adjustment intended for providing additional functions and in particular to enable a more reliable carrying out of blank cuts.

This object is satisfied by the features of claim 1.

In accordance with the invention, an apparatus for slicing food products includes an adjustment device by means of which the cutting blade is movable in an adjustment direction relative to the blade holder.

The invention is based on a turning away from the previously prevailing opinion in the technical world according to which, for a movement of the cutting blade—e.g. away from the product—a corresponding movement of the blade holder, if not even of the total blade head or cutting head, necessarily has to be provided. In accordance with the invention, the cutting blade is not fixedly coupled to the blade holder, but there is rather a relative movability between the cutting blade and the blade holder in a specific direction. The corresponding relative movement can be brought about by means of the adjustment device as required. The cutting blade can in this manner temporarily be moved away from the product at times in order thus to carry out additional functions such as e.g. blank cuts. The adjustment of the blade can take place faster with a configuration of the cutting apparatus in accordance with the invention than with conventional systems since the blade holder does not also have to be moved for the adjustment and the mass to be accelerated is thus reduced.

The term “blade holder” is generally to be interpreted widely here. It is a question of a component or of an assembly at which the cutting blade is held directly or indirectly in whatever manner and relative to which the cutting blade is moved when the cutting blade should be adjusted.

The term “cutting blade” does not necessarily have to be understood as a single-piece whole here, i.e. it is possible in accordance with the invention, but not compulsory, that only a single component is adjusted with the cutting blade. The cutting blade can be fixedly or releasably connected, e.g. screwed, to a separate component, for example to a socket, which moves together with the cutting blade and serves, for example due to a corresponding configuration, to improve the guidance of the cutting blade.

Such an arrangement of cutting blade and separate component should also be considered a “cutting blade” in the sense of the invention.

Advantageous embodiments of the invention are also set forth in the dependent claims, in the description and in the drawing.

The adjustment device preferably moves only the cutting blade. The mass to be moved is thereby restricted to a minimum, which is advantageous with respect to a fast, precise and reliable adjustment. Furthermore, the construction problems in connection with the rotary journaling of the blade holder are also dispensed with since neither the blade holder nor the corresponding bearing component are involved in the adjustment movement.

In accordance with an embodiment, the blade holder includes a shaft section for the cutting blade driven in a rotating and/or revolving manner. The cutting blade can preferably be axially displaceably plugged onto the shaft section. The cutting blade can thus be guided on the blade holder, wherein an easy replaceability of the cutting blade is ensured. To secure the cutting blade on the shaft section, a removable securing element can be provided at the shaft section. The seat of the cutting blade on the shaft section is expediently such that, on the one hand, a relatively easy sliding displaceability of the cutting blade is made possible and, on the other hand, no play, or at least no excessive play, occurs.

To be able to drive the cutting blade in a rotating manner via the blade holder, the cutting blade and the blade holder can be able to be coupled to one another by means of an engagement device, in particular a toothed arrangement, such that a rotary taking along of the cutting blade by the blade holder and the relative movement of the cutting blade in the adjustment direction are simultaneously made possible. The engagement device can in particular act in form-fitted manner since hereby the direction selectivity can be provided which is required for an axial displaceability. A section can, for example, be formed at a shaft section of the blade holder which cooperates with a cooperating profile at a cut-out of the cutting blade.

The blade holder is preferably in a fixed position viewed in an adjustment direction. The blade holder can in particular be in a fixed position relative to a base frame of the apparatus viewed in an adjustment direction, e.g. relative to a slicer rack or to a slicer frame. Apart from the adjustment direction, the blade holder can naturally be movable, for example in accordance with a rotating and/or revolving drive of the cutting blade or in accordance with other setting or adjustment movements of the associated blade head or blade edge head. In this embodiment, no separate adjustment apparatus has to be provided for the blade holder.

The cutting blade can in particular be linearly displaceable relative to the blade holder. The adjustment direction preferably extends parallel to the blade axis and/or to the center axis. This allows a particularly simple construction since only a linear guide of the cutting blade at the blade holder has to be provided.

Alternatively, the adjustment device can be configured to generate a tilting movement and/or wobbling movement of the cutting blade. This movement of the cutting blade can be coordinated with its rotary movement and/or revolutionary movement. This movement of the cutting blade can furthermore take place cyclically and/or periodically.

It is therefore admittedly generally possible in accordance with the invention, but not compulsory, to move the cutting blade so that the desired adjustment is adopted over the total circumference of the cutting blade at all times. A movement of the cutting blade relative to the blade holder can namely also take place in accordance with the invention such that the desired adjustment is only adopted over a partial circumferential region of the cutting blade, e.g. only a part region of the blade edge is moved away from the product. In this concept, the movement of the cutting blade can be coordinated with its rotary speed for the reliable avoidance of scrap formation. For example, the cutting blade is tilted or set into a wobble movement in the manner of the cyclic blade adjustment in the rotor of a helicopter during the adjustment operation, that is outside the normal cutting operation. In particular, in each case just that peripheral region of the still rotating and/or revolving cutting blade is adjusted, in particular moved away from the front product end, which would cut into the product without an adjustment movement.

It is consequently not necessary that the cutting blade as a whole carries out a linear movement directed in any manner relative to the blade holder. The desired adjustment can rather take place e.g. in that, in conjunction with the carrying out of blank cuts, the cutting blade is set, by means of the adjustment device, into a wobble movement coordinated with its rotary movement and/or revolutionary movement such that scrap formation is reliably avoided.

Such an adjustment movement, in particular representing a tilt movement and/or wobble movement, of the cutting blade is also an adjustment movement of the cutting blade relative to the blade holder in an adjustment direction in the sense of the invention.

To fix a first end position and a second end position of the cutting blade, abutments for the cutting blade can be provided at the blade holder. The abutments can simultaneously serve for securing the movable cutting blade to the blade holder and for fixing the maximum adjustment stroke. The adjustment stroke can be adapted to different applications by abutment elements which are replaceable or are in turn adjustable.

In accordance with an embodiment of the invention, the adjustment device includes an adjustment element which can be actuated electrically, hydraulically or pneumatically and which acts on the movable cutting blade. In this respect, the adjustment element can act directly on the cutting blade or suitable transmission elements can be provided for transferring the adjustment force of the adjustment element to the cutting blade.

In accordance with a further embodiment, a region of the cutting blade forms a piston of a pneumatically actuable adjustment element. This allows a particularly inexpensive and space saving construction. Membranes or folding bellows can be provided to seal a cylinder of the pneumatically actuable adjustment element with respect to the cutting blade acting as a piston.

The adjustment device can include at least one electromagnet which acts on the cutting blade. With such an embodiment, no force transmission elements have to engage at the cutting blade so that it can be designed particularly simply. Conventional cutting blades can in particular be used without any additional construction adaptations.

The adjustment device can also include an element which is displaceable at the blade holder and which is in communication with the cutting blade via a coupling device. The adjustment movement can be transferred in a simple manner by means of the displaceable element and the coupling device from a drive element of the adjustment device to the cutting blade. For example, the displaceable element can be a sliding sleeve which is slidingly supported on a shaft section of the blade holder.

The coupling device can include at least one articulated lever, in particular a plurality of articulated levers arranged distributed in the peripheral direction at the displaceable element. The articulated levers can be attached in the manner of an umbrella at one end to a sliding sleeve and engage at the cutting blade at the other end. Optionally, the articulate levers can each include two or more mutually pivotable parts or can be configured changeable in length in a different manner.

In accordance with a further embodiment of the invention, the blade holder is a component of a blade head which is in a fixed position viewed in the adjustment direction. Since the blade head is in a fixed position, a corresponding adjustment device for the blade head can be saved.

The blade head can be configured as a head of a scythe-like blade for a scythe-like blade rotating about the blade axis. Alternatively, the blade head can be configured as a circular blade head for a circular blade rotating about the blade axis and revolving about the center axis in planetary motion. The blade head can furthermore have at least one rotary drive associated with it which, together with the blade head, is arranged at or in a cutting head housing fixed to the rack. The rotary drive also does not necessarily have to be moved in accordance with the invention to adjust the cutting blade. If it is a case of a circular blade head, a single common drive can be provided for the rotation of the cutting blade, on the one hand, and for the revolution of the cutting blade, i.e. for the rotation about the center axis, on the other hand. It is, however, also possible to provide a distinct and/or separate drive, in particular mutually independent drives, for each of these movements.

In accordance with a further embodiment, the cutting blade is movable in the adjustment direction such that there is a spacing change between the cutting blade and a reference plane which extends parallel to a cutting plane defined by the blade edge of the cutting blade located in a cutting position. That plane is e.g. to be understood as the reference plane in which the front end of the product to be sliced, that is the instantaneous cutting surface of the product, at least approximately lies during the cutting operation. The adjustment movement of the cutting blade provides a sufficiently large spacing between the cutting plane always defined by the blade edge of the cutting blade and the front product end, whereby scrap formation is prevented. The reference plane can also coincide with that plane in which the cutting plane lies when the cutting blade is in the cutting position. Even if the cutting blade is not located in the cutting position, that is between the start and end of the adjustment procedure, the reference plane can extend parallel to the cutting plane. This depends on the specific manner of the adjustment movement of the cutting blade.

The cutting blade can in particular be movable in the adjustment direction to carry out at least one additional function, in particular to carry out blank cuts and/or to set the cutting gap.

The invention will be described in the following by way of example with reference to the drawing.

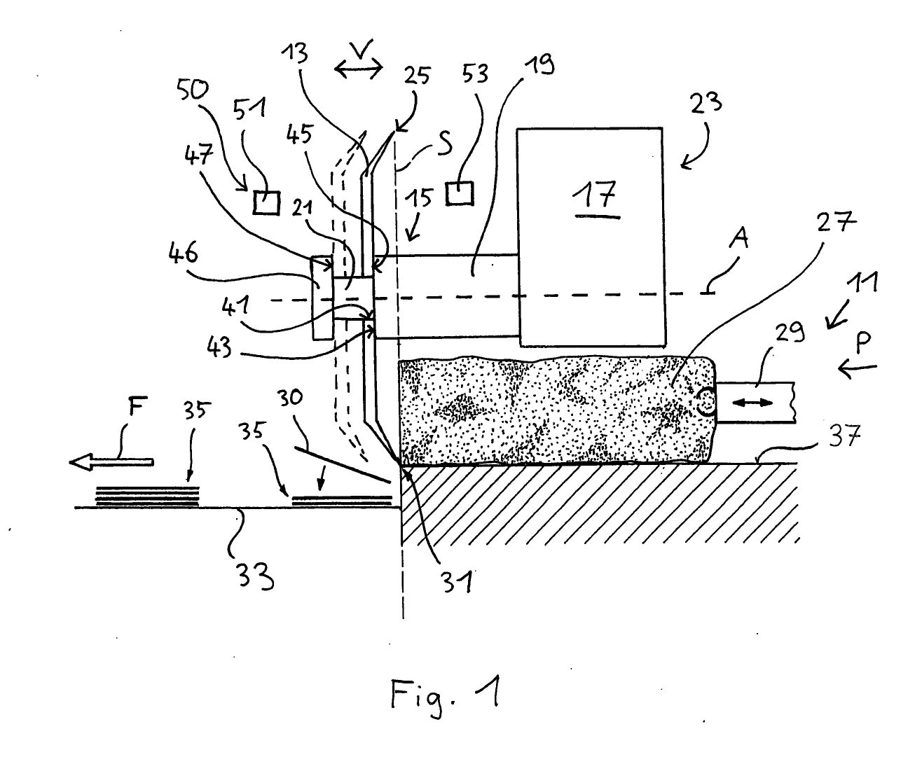

FIG. 1 shows a simplified representation of an apparatus for slicing food products in accordance with a first embodiment of the invention; and

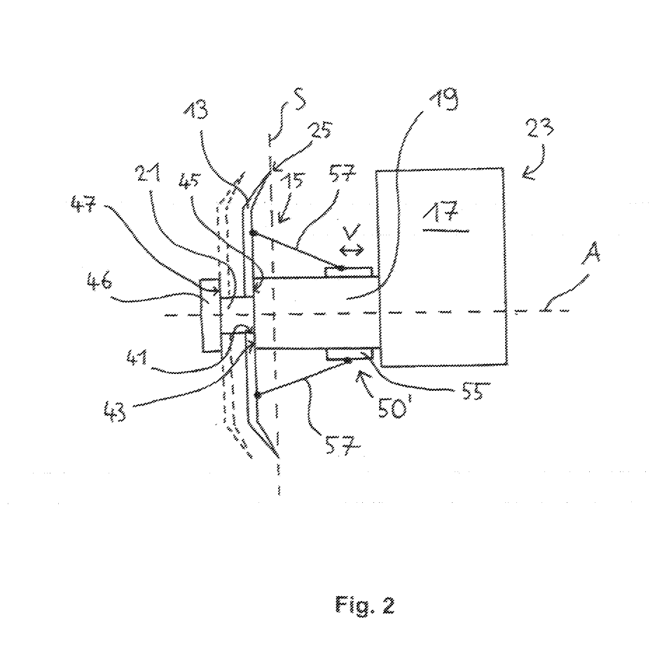

FIG. 2 shows a simplified representation of an apparatus for slicing food products in accordance with a second embodiment of the invention.

In accordance with FIG. 1, a high-performance slicer includes a product feed 11, a cutting blade 13 as well as a blade holder 15 for the cutting blade 13. The cutting blade 13 is here configured as a scythe-like blade which rotates about a blade axis A. The blade holder 15 is rotatably supported in a bearing 17 and includes a base section 19 as well as a plug-in section 21. A rotary drive, not shown, serves to set the blade holder 15 into a rotary movement about the blade axis A by means of a drive belt. The blade holder 15 together with the bearing 17 forms a blade head 23 which is attached together with the rotary drive in a fixed position in a cutting head housing, not shown, of the slicer.

A blade edge 25 of the cutting blade 13 always defines a cutting plane S extending at right angles to the blade axis A independently of the operating state of the cutting blade 13. A product bar 27 is located on a product support 37 of the product feed 11 and holding claws 29 engage at its rear end which are movable by a controlled drive, not shown, in and against a product feed direction P, which is shown by a double arrow in FIG. 1. The product bar 27 is fed along the product feed direction P of the cutting planes by means of the driven holding claws 29. Instead of as single product bar 27, a plurality of product bars arranged next to one another can also be fed to the cutting plane S together.

During the operation of the high-performance slicer, the rotating cutting blade 13 cuts through the product bar 27 with its blade edge 25 and cuts product slices 30 from said product bar, with it cooperating with a cutting edge 31 forming the end of the product support 37. The coincidence of the cutting plane S with a plane defined by the cutting edge 31 is lost to a simplified representation here. In practice, a small, usually adjustable cutting gap is present between the cutting blade 13 and the cutting edge 31, which does not however, have to be looked at in any more detail here. The advance speed of the product bar 27 and thus the thickness of the product slices 30 is in this respect adjustable by a corresponding control of the driven holding claws 29. The cut-off product slices 30 fall on the rear blade side remote from the product feed 11 onto a support 33 and can be conveyed further or processed further along a conveying direction F and can in particular be fed to an automatic packaging plant (not shown).

It can be seen from FIG. 1 that the slicing of the product bar 27 takes place portion-wise, i.e. the cut-off product slices 30 form portions 35 which are here shown as slice stacks. As soon as a portion 35 is complete, this portion 35 is transported off in the conveying direction F on the support 33. So that sufficient time is available for the transporting away of the finished portions 35, the above-mentioned blank cuts are carried out until the start of the formation of the next portion 35, for which purpose, on the one hand, the product advance also called a product feed—that is here the holding claws 29—is stopped and optionally retracted and, on the other hand, the cutting blade 13 is moved away from the front end of the product bar 27 into the position shown by dashed lines in FIG. 1. By moving the cutting blade 13 into this position spaced apart from the product bar 27, a scrap formation or snippet formation during the carrying out of blank cuts is reliably avoided.

The cutting blade 13 is plugged onto the plug-in section 21 of the blade holder 15. For this purpose, a leadthrough 41 is formed in the cutting blade 13 and is adapted to the outer dimensions of the plug-in section 21 such that the cutting blade 13 is slidingly displaceable in and against an adjustment direction V on the plug-in section 21. A nose 43 which forms a rear abutment 45 for the displaceable cutting blade 13 is formed between the plug-in section 21 and the base section 19 of the blade holder 15. A securing element 46 whose end face facing the cutting blade 13 forms a front abutment 47 for the cutting blade 13 is attached to the front end of the plug-in section 21. The securing element 46 can be removed from the plug-in section 21 in order e.g. to be able to carry out a replacement of the cutting blade 13.

Section structures, not shown, are provided at the leadthrough 41 of the cutting blade 13 as well as at the plug-in section 21 to allow a rotational taking along of the cutting blade 13 by the rotating blade holder 15. The cutting blade 13 is therefore fixed on the blade holder 15 in the radial direction and is furthermore rotationally fixedly connected thereto. In the axial direction with respect to the blade axis A, namely in the adjustment direction V, the cutting blade 13 is, however, movable relative to the blade holder 15.

For the controlled moving of the cutting blade 13 away from the front end of the product bar 27 and toward the front end of the product bar 27, an adjustment device 50 is provided which, in the embodiment in accordance with FIG. 1, is formed by two electromagnets 51, 53, only shown schematically here, which are arranged at oppositely disposed sides of the cutting blades 13 and are controlled by a control device, not shown. The electromagnets 51, 53 are configured such that they can quickly move the metallic cutting blades 13 into the respective end position preset by one of the abutments 45, 47 on a corresponding activation. To move the cutting blade 13 relative to the product bar 27, only the mass of the cutting blade 13 itself thus has to be accelerated, whereas all the other components of the slicer remain in fixed position with respect to the adjustment movement.

FIG. 2 shows a high performance slicer in accordance with an alternative embodiment of the invention, wherein the product feed and the product support—which are equivalent to the embodiment in accordance with FIG. 1—are not shown to simplify the product bar. The adjustment device 50′ includes a sliding sleeve 55 which is provided on the base section 19 of the blade holder 15 here and which can be moved to and fro by a setting drive, not shown, along the adjustment direction V. Articulated levers 57 which are pivotally connected to the cutting blade 13 at their end remote from the sliding sleeve 55 are pivotally connected to the outer surface of the sliding sleeve 55 arranged distributed in the peripheral direction. To provide a changeability of length of the articulated levers 57, they can be composed of at least two mutually pivotable parts, which is not shown in detail in FIG. 2. On a movement of the sliding sleeve 55, the articulated levers 57 exert a tension force or compressive force on the side of the cutting blade 13 facing the blade holder 15 and thus move said cutting blade into end positions defined by the abutments 45, 47.

To exert an adjustment force onto the cutting blade 13, differing from the embodiments presented above, a plurality of different transmission mechanisms are possible.

### REFERENCE NUMERAL LIST

11 product feed
13 cutting blade
15 blade holder
17 bearing
19 base section
21 plug-in section
23 blade head
25 blade edge
27 product bar
29 holding claws
30 product slice
31 cutting edge
33 support
35 portion
37 product support
41 leadthrough
43 nose
45 rear abutment
46 securing element
47 front abutment
50, 50′ adjustment device
51 electromagnet
53 electromagnet
55 sliding sleeve
57 articulated lever
A blade axis
S cutting plane
P product feed direction
F conveying direction
V adjustment direction

1. An apparatus for slicing food products (27) comprising
a product feed (11);
at least one cutting blade (13) which rotates about a blade axis (A) and/or revolves about a center axis in planetary motion and to which at least one product (27) to be sliced can be fed in a product feed direction (P);
a blade holder (15) to which the cutting blade (13) can be attached; and
an adjustment device (50, 50′) by means of which the cutting blade (13) is movable relative to the blade holder (15) in an adjustment direction (V).

2. An apparatus in accordance with claim 1,
wherein
it is a high-performance slicer.

3. An apparatus in accordance with claim 1,
wherein
the adjustment device (50, 50′) only moves the cutting blade (13).

4. An apparatus in accordance with claim 1,
wherein
the blade holder (15) includes a shaft section (21) for the cutting blade (13) driven in a rotating and/or revolving manner.

5. An apparatus in accordance with claim 1,
wherein
the cutting blade (13) and the blade holder (15) can be coupled to one another by means of an engagement device such that a rotary taking along of the cutting blade (13) by the blade holder (15) and the relative movement of the cutting blade (13) in the adjustment direction (V) are made possible simultaneously.

6. An apparatus in accordance with claim 1,
wherein
the cutting blade (13) and the blade holder (15) can be coupled to one another by means of a toothed arrangement such that a rotary taking along of the cutting blade (13) by the blade holder (15) and the relative movement of the cutting blade (13) in the adjustment direction (V) are made possible simultaneously.

7. An apparatus in accordance with claim 1,
wherein
the blade holder (15) is In fixed position viewed in the adjustment direction (V).

8. An apparatus in accordance with claim 1,
wherein
the cutting blade (13) is linearly displaceable relative to the blade holder (15); and/or in that the cutting blade (13) can be excited to make a tilt movement and/or wobble movement relative to the blade holder (15).

9. An apparatus in accordance with claim 1,
wherein
the adjustment direction (V) extends parallel to the blade axis (A) and/or to the center axis.

10. An apparatus in accordance with claim 1,
wherein
abutments (45, 47) for the cutting blade (13) are provided at the blade holder (15) to fix a first end position and a second end position of the cutting blade (13).

11. An apparatus in accordance with claim 1,
wherein
the adjustment device (50, 50′) includes an adjustment element which is actuable electrically, hydraulically or pneumatically and which acts on the movable cutting blade (13).

12. An apparatus in accordance with claim 11,
wherein
a region of the cutting blade forms a piston of a pneumatically actuable adjustment element.

13. An apparatus in accordance with claim 1,
wherein
the adjustment device (50) includes at least one electromagnet (51, 53) which acts on the cutting blade (13).

14. An apparatus in accordance with claim 1,
wherein
the adjustment device (50′) includes an element (55) displaceable at the blade holder (15) and in communication with the cutting blade (13) via a coupling device (57).

15. An apparatus in accordance with claim 14,
wherein
the coupling device (57) includes at least one articulated lever, in particular a plurality of articulated levers arranged distributed in the peripheral direction at the displaceable element (57).

16. An apparatus in accordance with claim 1,
wherein
the blade holder (15) is a component of a blade head (23) which is in fixed position viewed in the adjustment direction (V).

17. An apparatus in accordance with claim 1,
wherein
a blade head (23) is configured as a scythe-like blade head for a scythe-like blade (13) rotating about the blade axis (A).

18. An apparatus in accordance with claim 1,
wherein
a blade head is configured as a circular blade head for a circular blade rotating about the blade axis and revolving about the center in planetary motion.

19. An apparatus in accordance with claim 1,
wherein
at least one rotary drive is associated with a blade head (23).

20. An apparatus in accordance with claim 17,
wherein
the rotary drive is arranged together with the blade head (23) at or in a cutting head housing fixed to the rack.

21. An apparatus in accordance with claim 1,
wherein
the cutting blade (13) is movable in the adjustment direction (V) such that there is a change in the spacing between the cutting blade (13) and a reference plane which extends parallel to a cutting plane (S) defined by the blade edge (25) of the cutting blade (13) located in a cutting position.

22. An apparatus in accordance with claim 1,
wherein
the cutting blade (13) is movable in the adjustment direction (V) for carrying out at least one additional function, in particular for carrying out blank cuts and/or for the cutting gap setting.

23. An apparatus in accordance with claim 1,
wherein
the cutting blade (13) is movable in the adjustment direction (V) for carrying out blank cuts and/or for the cutting gap setting.
